(19) United States
(12) Patent Application Publication
(10) Pub. No.: US 2020/0201438 A1
(43) Pub. Date: Jun. 25, 2020

(54) Haptic Fiducial Sticker

(71) Applicant: Immersion Corporation, San Jose, CA (US)

(72) Inventors: Alexia Mandeville, San Jose, CA (US); Sanya Attari, Fremont, CA (US); Douglas G. Billington, Campbell, CA (US); Christopher J. Ullrich, Ventura, CA (US)

(21) Appl. No.: 16/231,811

(22) Filed: Dec. 24, 2018

(51) Int. Cl. G06F 3/01; G06F 3/041; G06F 3/14

(52) U.S. Cl. CPC G06F 3/016; G06T 11/60; G06F 3/14; G06F 3/041

(57) ABSTRACT

The present invention provides a haptic fiducial sticker for an augmented reality (AR) environment. The haptic fiducial sticker includes a touch sensor, a wireless communication interface, and a haptic output device. The touch sensor is configured to detect a touch or user contact. The wireless communication interface is configured to transmit a unique identifier (UID) and receive haptic content associated with the UID, the haptic content including a haptic effect. The haptic output device is configured to render the haptic effect when the touch sensor detects the touch or user contact.

### TECHNICAL FIELD

The present invention relates to a haptic device. More particularly, the present invention relates to a haptic fiducial sticker.

### BACKGROUND

Computer-generated environments, such as, for example, augmented reality (AR) environments, virtual reality (VR) environments, computer games, etc., typically use visual and auditory cues to provide feedback to a user. In certain AR environments, the host electronic device may provide tactile feedback and/or kinesthetic feedback to the user. Tactile feedback is known as “tactile haptic feedback” or “tactile haptic effects,” and may include, for example, vibration, texture, temperature variation, etc. Kinesthetic feedback is known as “kinesthetic haptic feedback” or “kinesthetic haptic effects,” and may include, for example, active and resistive force feedback. In general, tactile and kinesthetic feedback are collectively known as “haptic feedback” or “haptic effects.” Haptic effects provide cues that enhance a user's interaction with the host electronic device, from augmenting simple alerts to specific events to creating a greater sensory immersion for the user within the AR environment.

In certain AR environments, fiducial markers may be placed in the user's physical environment to serve as reference points to facilitate tracking the position of the user's head mounted display (HMD) or any other device form enabling AR, VR, or mixed reality interactions. A camera, mounted to the device, views the user's physical environment, and the AR application detects any fiducial markers that may be present in the field of view of the camera. Fiducial markers are physical objects that are detected by their shape, color, or any other visual characteristic. For example, some fiducial markers may include a matrix barcode imprinted on a visible surface, such as a quick response (QR) code. While the AR application may respond to the detection of a fiducial marker by displaying computer-generated images within the AR environment, known fiducial markers are passive objects that do not interact with the user.

### SUMMARY

Embodiments of the present invention advantageously provide a haptic system for an AR environment, a haptic interface or fiducial sticker for an AR environment, and a method for rendering haptic content in a haptically-enabled AR system.

The haptic interface or fiducial sticker includes a touch sensor, a wireless communication interface, and a haptic output device. The touch sensor is configured to detect a touch or user contact. The wireless communication interface is configured to transmit a unique identifier (UID) and receive haptic content associated with the UID, the haptic content including a haptic effect. The haptic output device is configured to render the haptic effect when the touch sensor detects the touch or user contact.

### BRIEF DESCRIPTION OF THE DRAWINGS

FIG. 1 illustrates a block diagram of a haptically-enabled AR system, in accordance with an embodiment of the present invention.

FIG. 2 illustrates a block diagram of a haptic system for an AR environment, in accordance with an embodiment of the present invention.

FIG. 3 illustrates a block diagram of a haptic fiducial sticker for an AR environment, in accordance with an embodiment of the present invention.

FIG. 4A depicts a haptic fiducial sticker, FIG. 4B depicts visual content associated with the haptic fiducial sticker, and FIG. 4C depicts haptic content associated with the haptic fiducial sticker, in accordance with an embodiment of the present invention.

FIG. 5A depicts a haptic fiducial sticker, FIG. 5B depicts visual content associated with the haptic fiducial sticker, and FIGS. 5C and 5D depict haptic content associated with the haptic fiducial sticker, in accordance with another embodiment of the present invention.

FIG. 6 depicts a flow chart illustrating functionality for creating visual and haptic content in a haptically-enabled AR system, in accordance with an embodiment of the present invention.

FIG. 7 depicts a flow chart illustrating functionality for rendering haptic content in a haptically-enabled AR system, in accordance with an embodiment of the present invention.

FIGS. 8 and 9 depict optional functionality for rendering haptic content in a haptically-enabled AR system, in accordance with an embodiment of the present invention.

FIG. 10 depicts a flow chart illustrating functionality for rendering haptic content for a haptically-enabled AR system, in accordance with an embodiment of the present invention.

### DETAILED DESCRIPTION

Embodiments of the present invention will now be described with reference to the drawing figures, in which like reference numerals refer to like parts throughout. Embodiments of the present invention advantageously provide a haptic system for an AR environment, a haptic fiducial sticker for an AR environment, and a method for rendering haptic content in a haptically-enabled AR system.

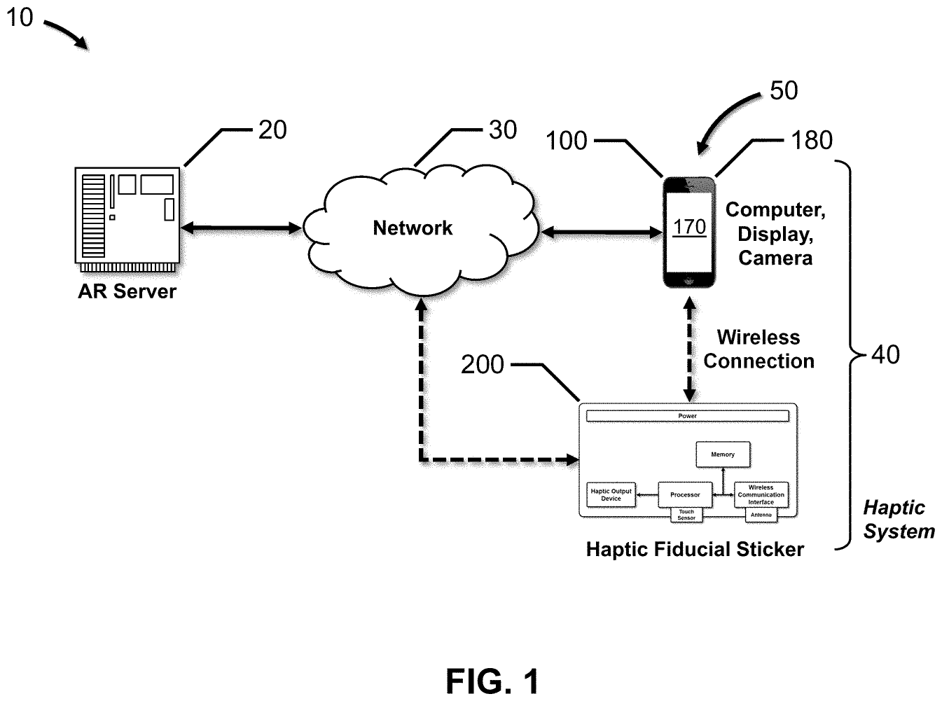

FIG. 1 illustrates a block diagram of a haptically-enabled AR system, in accordance with an embodiment of the present invention. Haptically-enabled AR system 10 includes AR server 20, network 30, and haptic system 40.

AR server 20 is a computer on which a content developer creates visual and haptic content for an AR application. In certain embodiments, AR server 20 also publishes, hosts, serves, etc., the AR application for haptic system 40.

Network 30 may include various combinations of wired and/or wireless networks, such as, for example, copper wire or coaxial cable networks, fiber optic networks, Bluetooth wireless networks, WiFi wireless networks, CDMA, FDMA and TDMA cellular wireless networks, etc., which execute various network protocols, such as, for example, wired and wireless Ethernet, Bluetooth, etc.

In this embodiment, haptic system 40 includes smartphone 50 and one or more haptic fiducial stickers 200. Smartphone 50 includes computer 100, display 170, and one or more input/output (I/O) devices 180 (e.g., a camera), as discussed in more detail below.

AR server 20 and smartphone 50 are connected to network 30. While haptic fiducial stickers 200 are typically not connected to network 30, in certain examples, haptic fiducial stickers 200 may be connected to network 30.

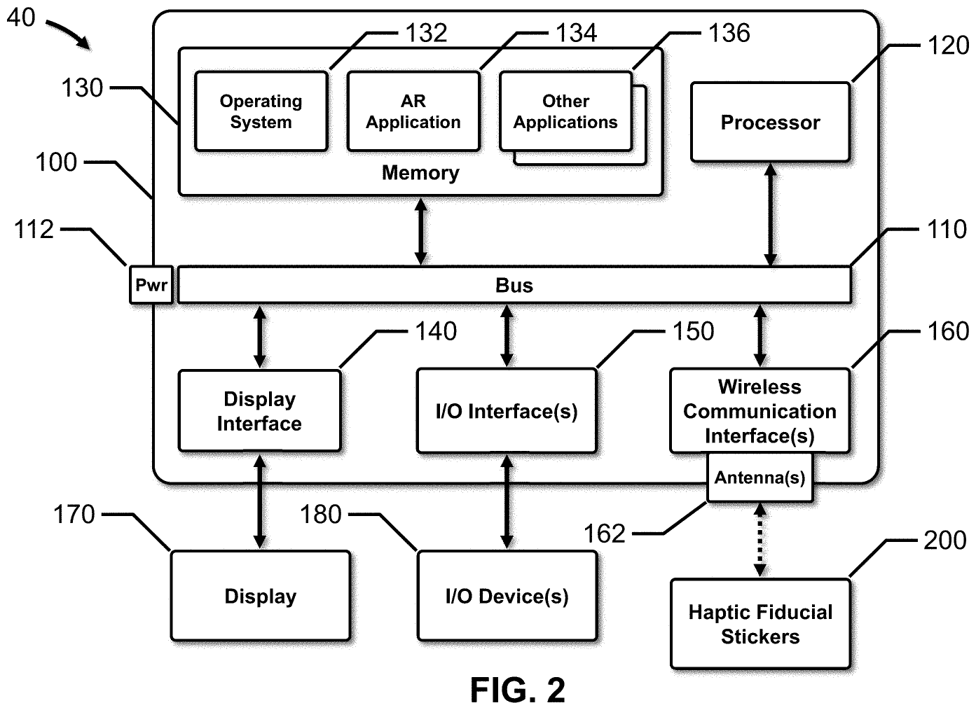

FIG. 2 illustrates a block diagram of a haptic system for an AR environment, in accordance with an embodiment of the present invention. Haptic system 40 includes computer 100, display 170, one or more I/O devices 180, and haptic fiducial stickers 200.

Computer 100 may be incorporated into a portable electronic device, such as, for example, a smartphone, a smartwatch, a portable gaming device, a virtual reality headset, etc. Computer 100 includes bus 110, processor 120, memory 130, display interface 140, I/O interface(s) 150, and wireless communication interface(s) 160. Display interface 140 is coupled to display 170. I/O interface 150 is coupled to I/O device 180. Generally, wireless communication interface 160 may be wirelessly coupled to haptic fiducial sticker 200 when computer 100 is within wireless communication range, which may vary depending on the particular wireless communication protocol. Bus 110 is a communication system that transfers data between processor 120, memory 130, display interface 140, I/O interface 150, and wireless communication interface 160, as well as other components not depicted in FIG. 1. Power connector 112 is coupled to bus 110 and a power supply (not shown), such as a battery, etc.

Processor 120 includes one or more general-purpose or application-specific microprocessors to perform computation and control functions for computer 100. Processor 120 may include a single integrated circuit, such as a micro-processing device, or multiple integrated circuit devices and/or circuit boards working in cooperation to accomplish the functions of processor 120. In addition, processor 120 may execute computer programs, such as operating system 132, AR application 134, other applications 136, etc., stored within memory 130.

Memory 130 stores information and instructions for execution by processor 120. Memory 130 may contain various components for retrieving, presenting, modifying, and storing data. For example, memory 130 may store software modules that provide functionality when executed by processor 120. The modules may include an operating system 132 that provides operating system functionality for computer 100. The modules may also include AR application 134 that serves visual and haptic content to a user. In certain embodiments, AR application 134 may include a plurality of modules, each module providing specific individual functionality for serving visual and haptic content to a user. Applications 136 may include other applications that cooperate with AR application 134 to serve visual and haptic content to the user.

Generally, memory 130 may include a variety of non-transitory computer-readable medium that may be accessed by processor 120. In the various embodiments, memory 130 may include volatile and nonvolatile medium, non-removable medium and/or removable medium. For example, memory 130 may include any combination of random access memory (“RAM”), dynamic RAM (DRAM), static RAM (SRAM), read only memory (“ROM”), flash memory, cache memory, and/or any other type of non-transitory computer-readable medium.

Display interface 140 is coupled to display 170.

I/O interface 150 is configured to transmit and/or receive data from I/O device 180. I/O interface 150 enables connectivity between processor 120 and I/O device 180 by encoding data to be sent from processor 120 to I/O device 180, and decoding data received from I/O device 180 for processor 120. Data may be sent over a wired connection such as a Universal Serial Bus (USB) connection, Ethernet, etc., or a wireless connection such as Wi-Fi, Bluetooth, etc.

Wireless communication interface 160 is coupled to antenna 162. Wireless communication interface 160 provides a wireless connection with haptic fiducial stickers 200 using one or more wireless protocols. A variety of low power wireless communication techniques may be used including Bluetooth, Bluetooth Low Energy (BLE), iBeacon, Radio-Frequency Identification (RFID), Near Field Communication (NFC), etc.

Display 170 may be a liquid crystal display (LCD) of a smartphone, an

LCD of an AR headset, image projectors and lenses of a pair of AR glasses, etc.

Generally, I/O device 180 is a peripheral device configured to provide input to computer 100, and may provide haptic feedback to a user. I/O device 180 is operably connected to computer 100 using either a wireless connection or a wired connection. I/O device 180 may include a local processor coupled to a communication interface that is configured to communicate with computer 100 using the wired or wireless connection.

I/O device 180 may be a camera that provides a forward-looking video image of the physical environment seen by the user.

In one example, computer 100, display 170 and I/O device 180 (i.e., a camera) are incorporated into smartphone 50, as depicted in FIG. 1. Smartphone 50 may be handheld or mounted in an AR headset. In another example, computer 100, display 170 and the camera are incorporated into an AR headset. In a further example, display 170 and the camera are incorporated into an AR headset or AR glasses, while computer 100 is a separate electronic device communicatively coupled to the AR headset or the AR glasses. For AR headsets and smartphone-based head mounted devices (HDMs), the computer-generated AR environment is overlaid onto the video image provided by the camera and then displayed in display 170. For AR glasses, the physical environment is viewed directly through the lenses, and the computer-generated AR environment is projected onto the lenses.

I/O device 180 may be a wearable device. For example, I/O device 180 may be a haptic glove, a smartwatch, a smartbracelet, a fingertip haptic device (FHD), etc.

I/O device 180 may include one or more sensors. A sensor is configured to detect a form of energy or other physical property, and convert the detected energy, or other physical property, into an electrical signal. I/O device 180 then sends the converted signal to I/O interface 150.

Generally, the sensor may be an acoustical or sound sensor, an electrical sensor, a magnetic sensor, a pressure sensor, a motion sensor such as an accelerometer, etc., a navigation sensor such as Global Positioning System (GPS) receiver, etc., a position sensor, a proximity sensor, a movement-related sensor, an imaging or optical sensor such as a camera, a force sensor, a temperature or heat sensor, etc. The sensor may include smart materials, such as piezo-electric polymers, which, in some embodiments, function as both a sensor and an actuator.

I/O device 180 may include one or more haptic output devices, such as a haptic actuator, etc. The haptic output device outputs haptic effects such as vibrotactile haptic effects, kinesthetic haptic effects, deformation haptic effects, etc., in response to receiving a haptic signal.

Generally, the haptic output device may be an electric motor, an electro-magnetic actuator, a voice coil, a shape memory alloy, an electro-active polymer, a solenoid, an eccentric rotating mass motor (“ERM”), a harmonic ERM motor (“HERM”), a linear actuator, a linear resonant actuator (“LRA”), a piezoelectric actuator, a high bandwidth actuator, an electroactive polymer (“EAP”) actuator, an electrostatic friction display, an ultrasonic vibration generator, etc. In some instances, the haptic actuator may include an actuator drive circuit.

Haptic fiducial stickers 200 are electronic devices that provide haptic feedback directly to the user when touched or contacted by the user or can facilitate the activation of haptics on other form factors as a result of a visual scan. In certain embodiments, when the user is proximate to a haptic fiducial sticker 200, I/O device 180 may provide haptic feedback to the user either in combination with, or independent of, any haptic feedback provided directly to the user by haptic fiducial sticker 200.

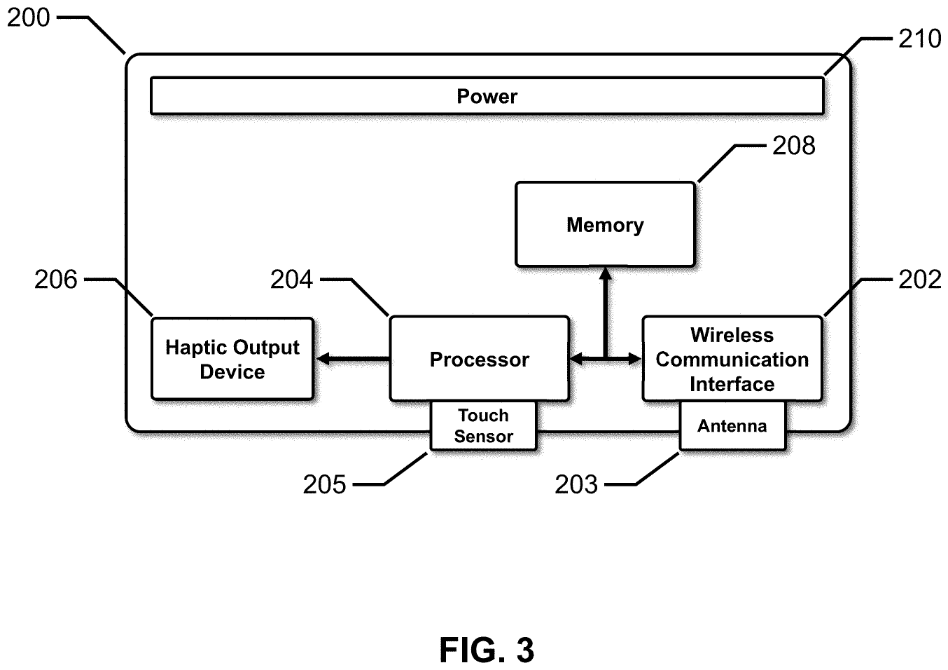

FIG. 3 illustrates a block diagram of a haptic fiducial sticker for an AR environment, in accordance with an embodiment of the present invention.

Haptic fiducial sticker 200 includes wireless communication interface 202, processor 204, haptic output device 206, memory 208 and power source 210.

Haptic fiducial sticker 200 has a unique identifier (UID) encoded within a non-volatile memory of processor 204 or within memory 208. Touch sensor 205 is coupled to processor 204. In certain embodiments, processor 204 is not present, and wireless communication interface 202 is coupled to touch sensor 205 and haptic output device 206. In these embodiments, the UID may be encoded within a non-volatile memory of wireless communication interface 202 or within memory 208.

Many different technologies may be used to sense a user's touch, contact or proximity, such as capacitive sensors, optical sensors, proximity sensors, voltage change circuits, touch force sensors, etc.

Capacitive sensors detect a change in capacitance when a finger or object touches, contacts, or is in close proximity to the capacitive sensor. While capacitive sensors typically include a small, thin sheet of conductive material, such as copper foil, any properly conductive material may be used. Capacitive sensors may include metal traces on a printed circuit board (PCB) or flex circuit, and are very inexpensive. The detection circuit for a capacitive sensor may be, for example, a single integrated circuit (IC) that uses oscillators to detect the change in capacitance. In another example, processor 204 may include a built-in capacitor sensing (CAP SENSE) circuit accessible through a port pin. Other detection circuit designs are also contemplated.

Certain optical sensors detect reflected or interrupted light in the infrared, visible, or ultraviolet portion of the electromagnetic spectrum. These optical sensors include a “transmitter” that transmits light, and a “receiver” that detects the amount of light received from the transmitter. When the light is reflected or interrupted and the amount of detected light falls below a particular threshold, the optical sensor provides a notification that a touch or contact event has occurred. Other optical sensors may include a “receiver” but not a “transmitter.” These optical sensors operate on ambient light, and may also detect proximity events.

Proximity sensors do not necessarily require that the user touch or contact the sensor; instead, a proximity sensor detects when a user “is proximate to” to the sensor. For example, certain proximity sensors operate using a “charge-transfer” principle to detect the presence of a finger, hand, object, etc., at a particular distance, even through a dielectric material. Many proximity sensors may detect touch as well as proximity. For example, the Quantum QT240-ISSG is a self-contained digital sensor IC capable of detecting touch or near-proximity. Other proximity sensors may include many different sensing technologies. For example, the Azoteq IQS621 is a multifunctional, ambient light sensing (ALS), capacitance, Hall-effect and inductive sensor.

Voltage change circuits are simple, one-shot digital devices that detect touch or contact by “triggering” off the small voltage present when a finger touches metal attached to a trigger pin. For example, the Signetics NE555 time IC may be used as a flip-flop element in this type of touch or contact detection circuit, which detects the change in voltage caused by the user's finger. Touch force sensors include strain gauges and force sensing resistors (FSRs), which may also be used for touch or contact detection. The Interlink FSR 400 is an FSR sensor that is optimized for use in human touch control of electronics devices.

Wireless communication interface 202 is connected to antenna 203, and provides a wireless connection with computer 100. Wireless communication interface 202 may provide one or more wireless communication protocols, including Bluetooth, Bluetooth Low Energy (BLE), iBeacon, Radio-frequency identification (RFID), Near Field Communication (NFC), etc.

Haptic output device 206 may provide vibrotactile haptic effects, kinesthetic haptic effects, deformation haptic effects, temperature haptic effects, olfactory haptic effects, etc. Haptic output device 206 may be, for example, an electric motor, an electro-magnetic actuator, a voice coil, a shape memory alloy, an electro-active polymer, a solenoid, an eccentric rotating mass motor (“ERM”), a harmonic ERM motor (“HERM”), a linear actuator, a linear resonant actuator (“LRA”), a piezoelectric actuator, a high bandwidth actuator, an electroactive polymer (“EAP”) actuator, an electrostatic friction display, an ultrasonic vibration generator, an olfactory effect or scent generator, etc. In some instances, the haptic actuator may include an actuator drive circuit. While a single haptic output device 206 is depicted in FIG. 3, other examples of haptic fiducial sticker 200 may include multiple haptic output devices 206 that render different haptic effects, such as, for example, a vibration haptic effect and an olfactory haptic effect, etc.

In certain embodiments, haptic content associated with the UID is stored in memory 208. The haptic content includes one or more haptic effects. In these embodiments, haptic fiducial sticker 200 renders the haptic effect stored in memory 208 to the user when touched or contacted by the user.

Power source 210 is coupled to wireless communication interface 202, processor 204, haptic output device 206, and memory 208. Power source 210 may include battery, solar, ambient radio frequency (RF), microbial fuel cell, piezoelectric, etc. Combinations of these power sources are also contemplated.

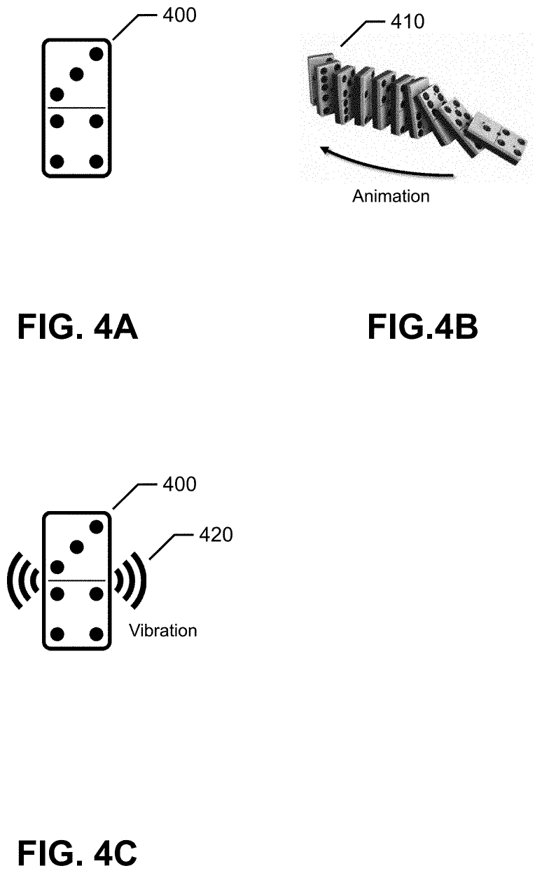

FIG. 4A depicts a haptic fiducial sticker, in accordance with an embodiment of the present invention.

Haptic fiducial sticker 400 is a physical representation of a game piece (i.e., a domino) that may be placed on an object in the physical environment, such as a table in a room of a house, a restaurant, etc. Haptic fiducial sticker 400 has a rectangular shape, and a front surface that is divided into two regions by a center line. Each region is marked with a number of spots, typically from zero spots to six spots. These physical characteristics facilitate visual detection of haptic fiducial sticker 400 by computer 100. Haptic fiducial sticker 400 has a back surface that may include a non-permanent adhesive, a non-slip material, rubber pads, etc., to temporarily (or permanently) attach haptic fiducial sticker 400 to the object in the physical environment and this will facilitate the relocating of the fixture for different purposes.

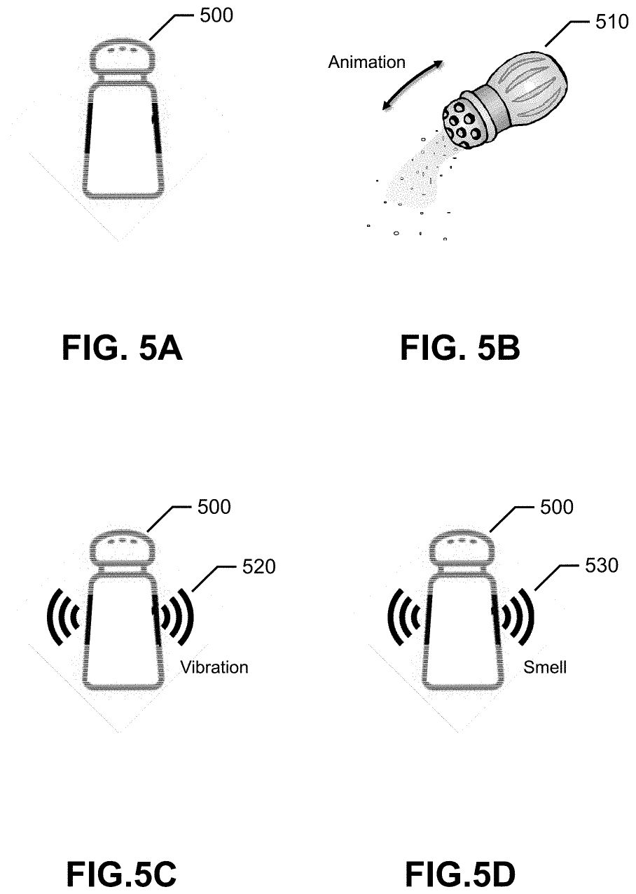

FIG. 5A depicts a haptic fiducial sticker, in accordance with another embodiment of the present invention.

Haptic fiducial sticker 500 is a physical representation of a salt shaker that may be placed on an object in the physical environment, such as a table in a restaurant, a house, etc. Haptic fiducial sticker 500 has an oblong shape, with an end in a dome shape. These physical characteristics facilitate visual detection of haptic fiducial sticker 500 by computer 100. Haptic fiducial sticker 500 also has a back surface that may include a non-permanent adhesive, a non-slip material, rubber pads, etc., to removably (or permanently) attach haptic fiducial sticker 500 to the object in the physical environment.

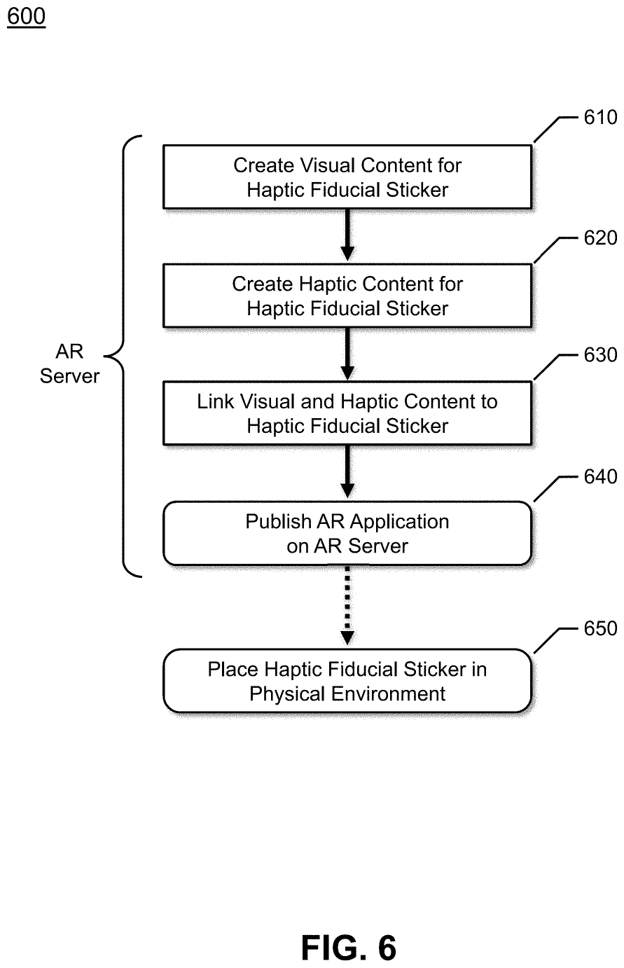

FIG. 6 depicts a flow chart illustrating functionality for creating visual and haptic content for a haptically-enabled AR system, in accordance with an embodiment of the present invention.

Generally, an AR application creates an AR environment that combines a visual depiction of a physical environment with computer-generated information such as, for example, visual information. Any AR application may incorporate the advantages of the haptic fiducial stickers described herein. Accordingly, AR server 20 may include content development software tools that allow a content developer to create and integrate visual content and haptic content into the AR application.

The AR application may create the visual depiction of the physical environment by receiving a video signal from a camera (I/O device 180), processing the video signal, and then displaying the video signal on display 170. Various portable electronic devices may be used to host the AR environment, including, for example, an AR headset (HMD) with a forward-looking camera, a head-mounted smartphone (HMD), a handheld smartphone, a helmet-mounted night vision device (NVD) with visible, near-infrared, infrared and/or thermal imaging, a handheld NVD, etc.

Alternatively, the user may view the physical environment directly through the lenses of a pair of AR glasses, and the AR application may project the computer-generated information onto the lenses (display 170) of the AR glasses. Even though the user views the physical environment directly, and more recent HMD models include a built-in camera, a camera (I/O device 180) may be mounted on the AR glasses in order to detect haptic fiducial sticker 200.

With respect to embodiment 600, at 610, visual content for a haptic fiducial sticker is created at AR server 20. The visual content may include graphics, 3D models, animations, etc. In one example, FIG. 4B depicts visual content for haptic fiducial sticker 400, which is an animation 410 (or animation sequence) of a line falling dominoes. In another example, FIG. 5B depicts visual content for haptic fiducial sticker 500, which is an animation 510 (or animation sequence) of a salt shaker dispensing salt. The visual content for haptic fiducial sticker 500 may also include a graphic (not shown) depicting a new menu item for a restaurant. Generally, creation of visual content for a particular haptic fiducial sticker 200 is optional.

At 620, haptic content for the haptic fiducial sticker is created at AR server 20. The haptic content may include vibrations, forces, temperatures, smells, etc. In one example, FIG. 4C depicts haptic content for haptic fiducial sticker 400, which is a vibratory haptic effect 420 associated with a line of falling dominoes. In another example, FIGS. 5C and 5D depict haptic content for haptic fiducial sticker 500. FIG. 5C depicts a vibratory haptic effect 520 associated with a salt shaker dispensing salt, while FIG. 5D depicts an olfactory haptic effect 530 associated with a salt shaker dispensing salt. For example, olfactory haptic effect 530 may include a selection of a particular scent identifier (ID) from a list of a pre-defined scents that are reproducible by a scent generator incorporated within haptic fiducial sticker 500.

At 630, the visual content and the haptic content are linked to a haptic fiducial sticker 200 at AR server 20. If visual content is created for the haptic fiducial sticker 200, the visual content is linked to the UID of the haptic fiducial sticker 200. For example, animation 410 is linked to the UID of haptic fiducial sticker 400, and animation 510 is linked to the UID of haptic fiducial sticker 500. Since haptic content is created for each haptic fiducial sticker 200, the respective haptic content is linked to the UID of each haptic fiducial sticker 200. For example, vibratory haptic effect 420 is linked to the UID of haptic fiducial sticker 400, and vibratory haptic effect 520 and olfactory haptic effect 530 are linked to the UID of haptic fiducial sticker 500.

Generally, the visual content may contain multiple elements, such as, one or more animations, 3D models, graphics, etc. Similarly, the haptic content may contain multiple elements, such as, one or more vibratory haptic effects, force feedback haptic effects, temperature haptic effects, olfactory haptic effects, etc.

Additionally, the haptic content may be customizable for each user. For example, if a particular haptic fiducial sticker 200 includes a haptic output device 206 that generates two different scents, e.g., a woman's perfume or a man's cologne, then the haptic content transmitted from computer 100 to the particular haptic fiducial sticker 200 would include a single scent effect, i.e., the woman's perfume for a female user or the man's cologne for a male user. Generally, the haptic content for a haptic fiducial sticker 200 may be filtered for a user according to certain user characteristics or settings, such as, gender, age, etc., or certain policies.

Other exemplary physical environments in which haptic fiducial stickers 200 may be placed include museums, grocery stores, etc. Museum exhibits lend themselves particularly well to enhancement via an AR environment with haptic fiducial stickers 200, as do grocery store product displays. Other exemplary uses for haptic fiducial stickers 200 include advertising, such as furniture, clothing, gaming, etc., and political campaigning.

At 640, the AR application, including the visual and haptic content, is published on AR server 20. Computer 100 may access the AR application on AR server 20 in several different ways.

For example, computer 100 may download a standalone AR application from AR server 20 over network 30, store the standalone AR application in memory 130, and then execute the standalone AR application using processor 120 to provide an AR environment to the user.

In another example, computer 100 may download a client AR application from AR server 20 over network 30, store the client AR application in memory 130, and then execute the client AR application using processor 120 to provide an AR environment in cooperation with a server AR application hosted by AR server 20.

In a further example, computer 100 may download a thin client AR application from AR server 20 over network 30, store the thin client AR application in memory 130 or memory that is local to processor 120, and then execute the thin client AR application using processor 120 to provide an AR environment in cooperation with a server AR application hosted by AR server 20. A thin client AR application may be preferred for certain implementations of computer 100 that lack extensive memory, etc., and typically apportions most of the functionality of the AR environment within the server AR application.

At 650, the haptic fiducial stickers are placed in the physical environment of a user. For example, haptic fiducial sticker 400 may be placed on a table in a room of a house, haptic fiducial sticker 500 may be placed on a table in a restaurant, etc.

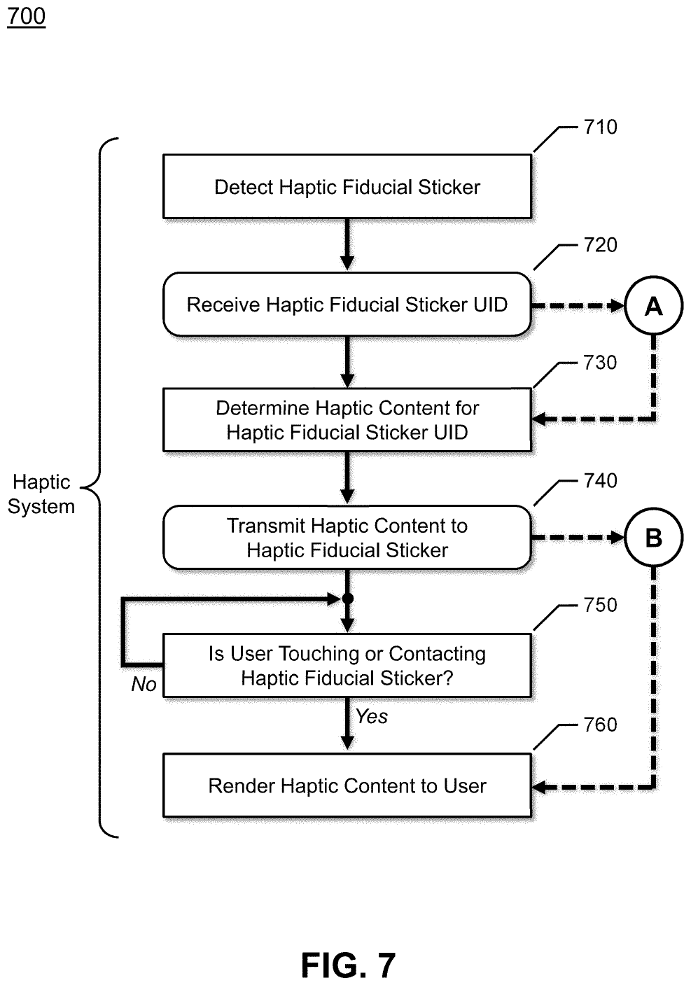

FIG. 7 depicts a flow chart illustrating functionality for rendering haptic content for a haptically-enabled AR system, in accordance with an embodiment of the present invention.

With respect to embodiment 700, at 710, computer 100 detects a haptic fiducial sticker 200. In one embodiment, the haptic fiducial sticker 200 may be detected using a camera (I/O device 180). For example, a particular visual characteristic of the haptic fiducial sticker 200 may be recognized in the field of view of the camera, such as a unique shape, unique markings, a QR code, etc.

In another embodiment, the haptic fiducial sticker 200 may be detected using a wireless signal between computer 100 and haptic fiducial sticker 200. For example, a wireless (Bluetooth, BLE, RFID, etc.) signal strength indicator may be used to determine the distance between computer 100 and haptic fiducial sticker 200. Haptic fiducial stickers 200 may be configured as active devices, or beacons, that continuously broadcast their UlDs. Alternatively, haptic fiducial stickers 200 may be configured as passive devices that listen for a wireless signal from computer 100, and once received, transmit their UlDs to computer 100 over the wireless connection.

In a further embodiment, computer 100 includes a GPS receiver (I/O device 180). For example, if the location of the haptic fiducial sticker 200 is known a priori, then computer 100 may detect whether the haptic fiducial sticker 200 is proximate to the user based on the location of haptic fiducial sticker 200 and GPS location information, such as latitude/longitude coordinates in decimal degrees (DD), degrees, minutes, seconds (DMS), etc.

At 720, computer 100 receives a UID from the haptic fiducial sticker 200 over a wireless connection between computer 100 and haptic fiducial sticker 200. In many examples, the wireless connection is established locally using Bluetooth, BLE, RFID, etc. In other examples, the wireless connection is established over network 30 using WiFi, etc. The UID may be received via a message formatted according to a standard or custom wireless communications protocol.

At 730, computer 100 determines the haptic content associated with the UID. For a standalone AR application 134, processor 120 looks up the haptic content associated with the UID in memory 130. For a client AR application 134, processor 120 communicates with AR server 20 over network 30 to determine the haptic content associated with the UID.

At 740, computer 100 transmits the haptic content associated with the UID to haptic fiducial sticker 200 over the wireless connection between computer 100 and haptic fiducial sticker 200. As before, in many examples, the wireless connection is established locally using Bluetooth, BLE, RFID, etc. In other examples, the wireless connection is established over network 30 using WiFi, etc.

At 750, haptic fiducial sticker 200 determines whether the user is touching or contacting haptic fiducial sticker 200 using, for example, one or more fingers, a hand, etc. If the user is touching or contacting haptic fiducial sticker 200, the flow continues.

At 760, the haptic content is rendered to the user. In one example, haptic fiducial sticker 200 renders the entire haptic effect to the user. The haptic effect may be a vibratory haptic effect, such as vibratory haptic effect 420, vibratory haptic effect 520, etc. The haptic effect may also be a force feedback haptic effect, a temperature haptic effect, a scent, such as olfactory haptic effect 530, etc.

In another example, haptic fiducial sticker 200 renders a first portion of the haptic effect to the user, and computer 100 renders a second portion of the haptic effect to the user via one or more haptic output devices (I/O devices 180). The first portion of the haptic effect may be a vibratory haptic effect rendered directly to the user's finger by haptic fiducial sticker 200, while the second portion of the haptic effect may be a different vibratory haptic effect rendered by the haptic output device. Alternatively, the vibratory haptic effects may be the same. With respect to timing, the first portion of the haptic effect may be rendered at the same time as the second portion of the haptic effect, the first portion of the haptic effect may be rendered at a different time than the second portion of the haptic effect, the rendering of the first portion of the haptic effect and the second portion of the haptic effect may partially overlap in time, etc. Computer 100 and the haptic output device may be provided in a wearable device in the user's possession. Various combinations of haptic effects are contemplated.

In a further example, computer 100 renders the haptic effect to the user by via one or more haptic output devices (I/O devices 180). For instance, an AR HMD (I/O device 180) scans a QR code on haptic fiducial sticker 200, and the relevant haptic effect is rendered by the haptic output device. Computer 100 and the haptic output device may be provided in a wearable device in the user's possession, such as a smartwatch, an AR HMD, etc. In this example, no direct user touch or contact is needed.

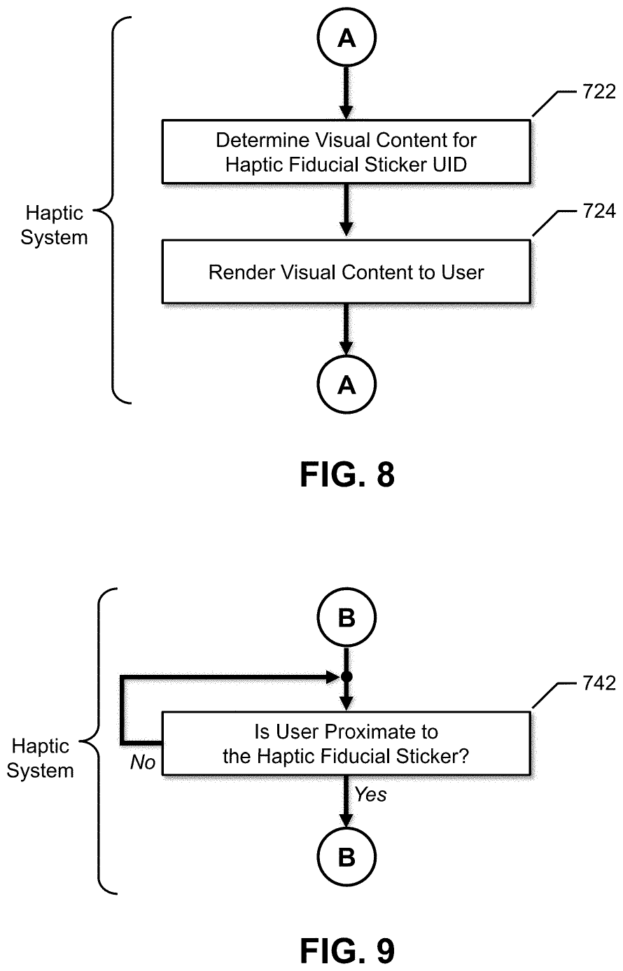

FIG. 8 depicts optional functionality for rendering haptic content in a haptically-enabled AR system, in accordance with an embodiment of the present invention.

After 720 (FIG. 7), at 722, computer 100 determines the visual content associated with the UID. For a standalone AR application 134, processor 120 looks up the visual content associated with the UID in memory 130. For a client AR application 134, processor 120 communicates with AR server 20 over network 30 to determine the visual content associated with the UID.

At 724, computer 100 renders the visual content associated with the UID to the user via display 170. For example, animation 410 may be rendered to the user via display 170, animation 510 may be rendered to the user via display 170, etc. The flow continues to 730 (FIG. 7).

FIG. 9 depicts optional functionality for rendering haptic content in a haptically-enabled AR system, in accordance with an embodiment of the present invention.

After 740 (FIG. 7), at 742, computer 100 determines whether the user is proximate to haptic fiducial sticker 200.

In one embodiment, proximity to haptic fiducial sticker 200 may be determined using a camera (I/O device 180). For example, the size of a particular visual characteristic of the haptic fiducial sticker 200 may be recognized in the field of view of the camera, such as a unique shape, unique markings, a QR code, etc., from which the proximity to haptic fiducial sticker 200 may be determined.

In another embodiment, proximity to haptic fiducial sticker 200 may be determined using a wireless (Bluetooth, BLE, RFID, etc.) signal between computer 100 and haptic fiducial sticker 200. For example, a wireless signal strength indicator may be used to determine the distance between computer 100 and haptic fiducial sticker 200.

In a further embodiment, proximity to haptic fiducial sticker 200 may be determined using a GPS receiver (I/O device 180). For example, if the location of the haptic fiducial sticker 200 is known a priori, then the proximity to haptic fiducial sticker 200 may be determined based on the known location of haptic fiducial sticker 200 and GPS location information, such as latitude/longitude coordinates in decimal degrees (DD), degrees, minutes, seconds (DMS), etc.

The distance, or proximity threshold, at which haptic fiducial sticker 200 is determined to be proximate to the user may be the same for all haptic fiducial stickers 200, such as, for example, 1 foot, 2 feet, 5 feet, 10 feet, etc. Alternatively, different haptic fiducial stickers 200 may have different proximity thresholds.

If the user is proximate to haptic fiducial sticker 200, the flow continues to 760 (FIG. 7), where the haptic content is rendered to the user. In one example, computer 100 renders the entire haptic effect to the user by via one or more wearable haptic output devices (I/O devices 180), such as a smartwatch, an AR HMD, etc. In this example, no direct user touch or contact with haptic fiducial sticker 200 is needed, and the haptic effect may be a vibratory haptic effect, such as vibratory haptic effect 420, vibratory haptic effect 520, etc., an olfactory haptic effect, such as olfactory haptic effect 530, etc., a force feedback haptic effect, a temperature haptic effect, etc. In another example, haptic fiducial sticker 200 renders a first portion of the haptic effect to the user, and computer 100 renders a second portion of the haptic effect to the user via one or more wearable haptic output devices (I/O devices 180), as discussed above. In a further example, haptic fiducial sticker 200 renders the entire haptic effect to the user. The haptic effect may be an olfactory haptic effect, such as olfactory haptic effect 530, etc. Other haptic effects may also be rendered by haptic fiducial sticker 200, such as a vibratory haptic effect, a force feedback haptic effect, a temperature haptic effect, etc., which would be experienced by the user upon contact with haptic fiducial sticker 200.

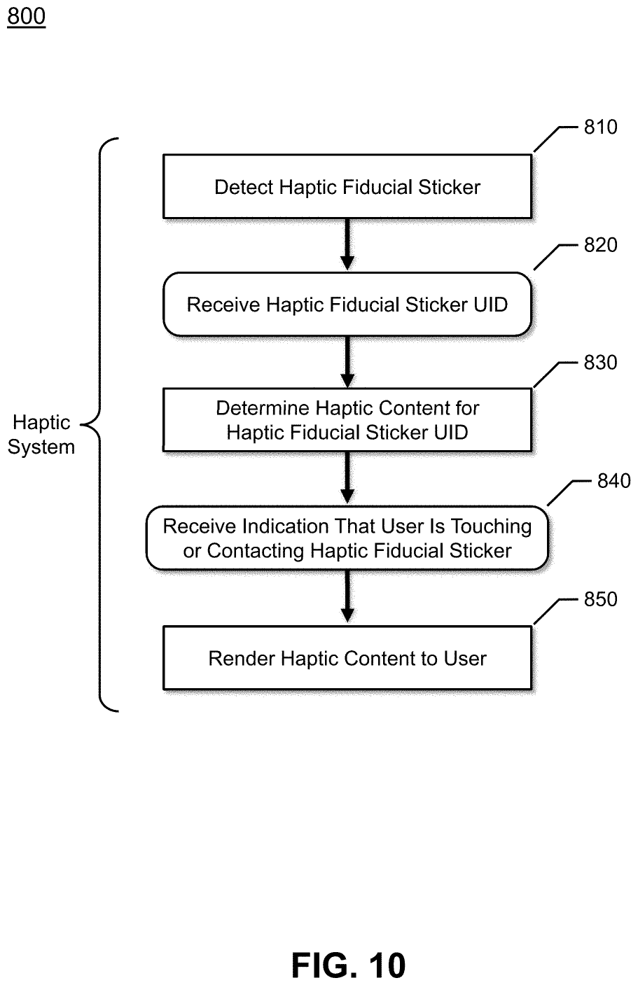

FIG. 10 depicts a flow chart illustrating functionality for rendering haptic content for a haptically-enabled AR system, in accordance with an embodiment of the present invention.

With respect to embodiment 800, at 810, computer 100 detects a haptic fiducial sticker 200. In one embodiment, the haptic fiducial sticker 200 may be detected using a camera (I/O device 180). For example, a particular visual characteristic of the haptic fiducial sticker 200 may be recognized in the field of view of the camera, such as a unique shape, unique markings, a QR code, etc.

In another embodiment, the haptic fiducial sticker 200 may be detected using a wireless signal between computer 100 and haptic fiducial sticker 200. For example, a wireless (Bluetooth, BLE, RFID, etc.) signal strength indicator may be used to determine the distance between computer 100 and haptic fiducial sticker 200. Haptic fiducial stickers 200 may be configured as active devices, or beacons, that continuously broadcast their UlDs. Alternatively, haptic fiducial stickers 200 may be configured as passive devices that listen for a wireless signal from computer 100, and once received, transmit their UlDs to computer 100 via a message formatted according to a standard or custom wireless communications protocol.

In a further embodiment, computer 100 includes a GPS receiver (I/O device 180). For example, if the location of the haptic fiducial sticker 200 is known a priori, then computer 100 may detect whether the haptic fiducial sticker 200 is proximate to the user based on the location of haptic fiducial sticker 200 and GPS location information, such as latitude/longitude coordinates in decimal degrees (DD), degrees, minutes, seconds (DMS), etc.

At 820, computer 100 receives a UID from the haptic fiducial sticker 200 over a wireless connection between computer 100 and haptic fiducial sticker 200. In many examples, the wireless connection is established locally using Bluetooth, BLE, RFID, etc. In other examples, the wireless connection is established over network 30 using WiFi, etc. The UID may be received via a message formatted according to a standard or custom wireless communications protocol.

At 830, computer 100 determines the haptic content associated with the UID. For a standalone AR application 134, processor 120 looks up the haptic content associated with the UID in memory 130. For a client AR application 134, processor 120 communicates with AR server 20 over network 30 to determine the haptic content associated with the UID.

At 840, receives a notification, from the haptic fiducial sticker 200 over a wireless connection between computer 100 and haptic fiducial sticker 200, that the user is touching or contacting haptic fiducial sticker 200 using, for example, one or more fingers, a hand, etc. The notification may include the UID of the haptic fiducial sticker 200 that the user is touching or contacting. The notification may be received via a message formatted according to a standard or custom wireless communications protocol.

At 850, the haptic content associated with the UID that the user is touching or contacting is rendered to the user. In this embodiment, computer 100 renders the haptic effect to the user by via one or more haptic output devices (I/O devices 180). Computer 100 and the haptic output device may be provided in a wearable device in the user's possession, such as a smartwatch, an AR HMD, etc. The haptic effect may be a vibratory haptic effect, a force feedback haptic effect, a temperature haptic effect, an olfactory haptic effect, etc.

One embodiment of the present invention provides a haptic system for AR environment. The haptic system includes a haptic fiducial sticker and a computer. The haptic fiducial sticker includes a touch sensor, a wireless communication interface, and a haptic output device. The touch sensor is configured to detect a touch or user contact. The wireless communication interface is configured to transmit a unique identifier (UID), and receive haptic content associated with the UID, the haptic content including a haptic effect. The haptic output device is configured to render the haptic effect when the touch sensor detects the touch or user contact. The computer includes a wireless communication interface and a processor. The wireless communication interface is configured to receive the UID from the haptic fiducial sticker, and transmit the haptic content associated with the UID to the haptic fiducial sticker. The processor configured to detect the haptic fiducial sticker, and determine the haptic content associated with the UID.

One embodiment of the present invention provides a haptic fiducial sticker for an AR environment. The haptic fiducial sticker includes a touch sensor, a wireless communication interface, and a haptic output device. The touch sensor is configured to detect a touch or user contact. The wireless communication interface is configured to transmit a unique identifier (UID) and receive haptic content associated with the UID, the haptic content including a haptic effect. The haptic output device is configured to render the haptic effect when the touch sensor detects the touch or user contact.

One embodiment of the present invention provides a method for rendering haptic content in a haptically-enabled AR system. The method includes detecting, by a processor of a computer, a haptic fiducial sticker; receiving, over a wireless connection, a unique identifier (UID) from the haptic fiducial sticker; determining haptic content associated with the UID, the haptic content including a haptic effect; transmitting, over the wireless connection, the haptic content associated with the UID to the haptic fiducial sticker; determining, by the haptic fiducial sticker, whether a user is touching or contacting the haptic fiducial sticker; and rendering the haptic effect to the user.

Another embodiment of the present invention provides a method for rendering haptic content in a haptically-enabled AR system. The method includes detecting, by a processor of a computer, a haptic fiducial sticker; receiving, over a wireless connection, a unique identifier (UID) from the haptic fiducial sticker; determining haptic content associated with the UID, the haptic content including a haptic effect; receiving, over the wireless connection, a notification from the haptic fiducial sticker that a user is touching or contacting the haptic fiducial sticker; and rendering the haptic effect to the user.

The various embodiments and examples described herein are combinable unless otherwise stated.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and, accordingly, all suitable modifications and equivalents may be resorted to that fall within the scope of the invention.

What is claimed is:

1. A haptic system for an augmented reality (AR) environment, comprising:
a haptic fiducial sticker including:
a touch sensor configured to detect a touch or user contact,
a wireless communication interface configured to transmit a unique identifier (U ID), and receive haptic content associated with the UID, the haptic content including a haptic effect, and
a haptic output device configured to render the haptic effect when the touch sensor detects the touch or user contact; and
a computer including:
a wireless communication interface configured to receive the UID from the haptic fiducial sticker, and transmit the haptic content associated with the UID to the haptic fiducial sticker, and
a processor configured to detect the haptic fiducial sticker, and determine the haptic content associated with the UID.

2. The haptic system according to claim 1, further comprising:
a camera, coupled to the computer, configured to output a video signal; and
a display, coupled to the computer, configured to display visual content associated with the UID,
wherein the processor is further configured to determine the visual content associated with the UID.

3. The haptic system according to claim 2, wherein the computer stores the haptic content and the visual content in a memory.

4. The haptic system according to claim 2, wherein the processor detects the haptic fiducial sticker based on the video signal.

5. The haptic system according to claim 1, wherein the processor detects the haptic fiducial sticker based on a wireless communication signal between the haptic fiducial sticker and the computer.

6. The haptic system according to claim 1, wherein the haptic fiducial sticker includes a processor coupled to the touch sensor, the wireless communication interface and the haptic output device.

7. The haptic system according to claim 1, wherein the haptic effect is a vibratory haptic effect.

8. The haptic system according to claim 1, wherein the haptic effect is a force feedback haptic effect, a temperature haptic effect, or an olfactory haptic effect.

9. The haptic system according to claim 1, wherein a first portion of the haptic effect is rendered by the haptic fiducial sticker, and a second portion of the haptic effect is rendered by haptic output device coupled to the computer.

10. A haptic fiducial sticker for an augmented reality (AR) environment, comprising:
a touch sensor configured to detect a touch or user contact;
a wireless communication interface configured to transmit a unique identifier (UID), and receive haptic content associated with the UID, the haptic content including a haptic effect; and
a haptic output device configured to render the haptic effect when the touch sensor detects the touch or user contact.

11. The haptic fiducial sticker according to claim 10, wherein the haptic fiducial sticker includes a processor coupled to the touch sensor, the wireless communication interface and the haptic output device.

12. The haptic fiducial sticker according to claim 10, wherein the haptic effect is a vibratory haptic effect, a force feedback haptic effect, a temperature haptic effect, or an olfactory haptic effect.

13. A method for rendering haptic content in a haptically-enabled augmented reality (AR) system, comprising:
detecting, by a processor of a computer, a haptic fiducial sticker;
receiving, over a wireless connection, a unique identifier (UID) from the haptic fiducial sticker;
determining haptic content associated with the UID, the haptic content including a haptic effect;
transmitting, over the wireless connection, the haptic content associated with the UID to the haptic fiducial sticker;
determining whether a user is touching or contacting the haptic fiducial sticker, or whether the user is proximate to the haptic fiducial sticker; and
rendering the haptic effect to the user.

14. The method according to claim 13, further comprising:
determining visual content associated with the UID;
displaying the visual content associated with the UID to a user.

15. The method according to claim 13, wherein the haptic effect is rendered by the haptic fiducial sticker.

16. The method according to claim 13, wherein:
the computer is a wearable device including a haptic output device;
a first portion of the haptic effect is rendered by the haptic fiducial sticker; and
a second portion of the haptic effect is rendered by the haptic output device.

17. The method according to claim 13, wherein the haptic fiducial sticker is detected based on a video signal generated by a camera coupled to the computer.

18. The method according to claim 13, wherein the haptic fiducial sticker is detected based on a wireless communication signal between the haptic fiducial sticker and the computer.

19. The method according to claim 13, wherein the haptic effect is a vibratory haptic effect.

20. The method according to claim 13, wherein the haptic effect is a force feedback haptic effect, a temperature haptic effect, or an olfactory haptic effect.
